(19) United States
(12) Patent Application Publication
(10) Pub. No.: US 2023/0006969 A1
(43) Pub. Date: Jan. 5, 2023

(54) MANAGEMENT APPARATUS, MANAGEMENT METHOD, AND PROGRAM

(71) Applicant: NEC Corporation, Minato-ku, Tokyo (JP)

(72) Inventor: Kentaro SONODA, Tokyo (JP)

(73) Assignee: NEC Corporation, Minato-ku, Tokyo (JP)

(21) Appl. No.: 17/780,637

(22) PCT Filed: Dec. 18, 2019
(86) PCT No.: PCT/JP2019/049650

§ 371 Date: May 27, 2022

(51) Int. Cl. H04L 9/40

(52) U.S. Cl. CPC H04L 63/0236; H04L 63/10; H04L 63/1441

(57) ABSTRACT

In order to appropriately manage address information that may be a target of access control, a management apparatus includes an address information obtain section configured to obtain address information as a management target for access control via a communication network, and a setting section configured to set, for the address information, an effective management period of the management target for the access control, based on information related to the address information.

### BACKGROUND

### Technical Field

The present invention relates to a management apparatus, a management method, and a program that perform management of address information as a management target for access control via a communication network.

### Background Art

In recent years, cyberattacks on the government, corporations, and the like have been increasing. Accordingly, cases that cause severe damage frequently occur. Defensive measures against such cyberattacks have been studied.

For example, as an example of the defensive measures, there are measures to repel cyberattacks, utilizing cyber threat intelligence (hereinafter also referred to as CTI). CTI is threat information gathering the origins of attacks, types, techniques, and the like of cyberattacks targeting the government and corporations. The government and corporations take countermeasures to forestall cyberattacks by utilizing CTI.

In CTI, pieces of information such as an IP address of the origin of an attack and a hash value indicating malware are mainly used. Such pieces of information are referred to as a block list, for example. In other words, the government and corporations use such a block list as, for example, an access control list (ACL) of a firewall, that is, a list of IP addresses to be repelled.

As a technique of generating an appropriate block list, for example, PTL 1 discloses that an attack type, an address of the origin of an attack, and the number of times of attacks are calculated from threat information and the like, and an address of the origin of an attack that satisfies a condition of exceeding a certain estimate cover rate can be registered as a block list.

### CITATION LIST

### Patent Literature

[PTL 1] JP 2019-004339 A

### SUMMARY

### Technical Problem

However, the block list may have a considerable volume. Thus, if all of the pieces of address information included in the block list are continuously managed as targets of access control, for example, performance of a firewall may deteriorate.

An example object of the present invention is to provide a management apparatus, a management method, and a program that enable appropriate management of address information that may be a target of access control.

### Solution to Problem

An example object of the present disclosure is to provide a management apparatus, an obtain section configured to obtain address information as a management target for access control via a communication network; and a setting section configured to set, for the address information, an effective management period of the management target for the access control, based on information related to the address information.

An example object of the present disclosure is to provide a management method, obtaining address information as a management target for access control via a communication network; and setting, for the address information, an effective management period of the management target for the access control, based on information related to the address information.

An example object of the present disclosure is to provide a program for causing a computer to execute, obtaining address information as a management target for access control via a communication network; and setting, for the address information, an effective management period of the management target for the access control, based on information related to the address information.

### ADVANTAGEOUS EFFECTS OF INVENTION

According to an example aspect of the present disclosure, it is possible to appropriate management of address information that may be a target of access control. Note that the present disclosure may exert other advantageous effects instead of the above advantageous effects or together with the above advantageous effects.

### BRIEF DESCRIPTION OF THE DRAWINGS

FIG. 1 is a block diagram illustrating an example of a schematic configuration of a management apparatus 100a according to a first example embodiment;

FIG. 2 is a diagram illustrating a specific example of threat information 200;

FIG. 3 is a flowchart illustrating a flow of an example of setting processing of an effective management period for an idle timeout;

FIG. 4 is a diagram illustrating a specific example of change of an effective management period for a hard timeout according to change of a risk value;

FIG. 5 is a flowchart illustrating a flow of an example of setting processing of the effective management period for an idle timeout;

FIG. 6 is a diagram illustrating a calculation case 600 of appearance frequency of addresses;

FIG. 7 is a flowchart illustrating a flow of an example of processing of adjusting the effective management periods;

FIG. 8 is a diagram illustrating a specific example of processing of updating the effective management periods;

FIG. 9 is a flowchart illustrating a flow of an example of processing performed by a determining section 137;

FIG. 10 is a diagram illustrating an example of information indicating the correspondence;

FIG. 11 is a time chart illustrating a flow of entire processing of the management apparatus 100a;

FIG. 12 is a block diagram illustrating an example of a schematic configuration of a management apparatus 100b according to an example alteration;

FIG. 13 is a time chart illustrating a flow of entire processing of the management apparatus 100b; and

FIG. 14 is a block diagram illustrating an example of a schematic configuration of a management apparatus 100c according to a second example embodiment.

### DESCRIPTION OF THE EXAMPLE EMBODIMENTS

Hereinafter, example embodiments of the present invention will be described in detail with reference to the accompanying drawings. Note that, in the Specification and drawings, elements to which similar descriptions are applicable are denoted by the same reference signs, and overlapping descriptions may hence be omitted.

Descriptions will be given in the following order.

1. Overview of Example Embodiments of Present Invention

2. First Example Embodiment
2.1. Configuration of Management Apparatus 100a
2.2. Operation Example
2.3. Example Alteration

3. Second Example Embodiment
3.1. Configuration of Management Apparatus 100c
3.2. Operation Example

4. Other Example Embodiments

### 1. Overview of Example Embodiments of Present Invention

First, an overview of example embodiments of the present invention will be described.

### (1) Technical Issue

In recent years, cyberattacks on the government, corporations, and the like have been increasing. Accordingly, cases that cause severe damage frequently occur. Defensive measures against such cyberattacks have been studied.

For example, as an example of the defensive measures, there are measures to repel cyberattacks, utilizing cyber threat intelligence (hereinafter also referred to as CTI). CTI is threat information gathering the origins of attacks, types, techniques, and the like of cyberattacks targeting the government and corporations. The government and corporations take countermeasures to forestall cyberattacks by utilizing CTI.

In CTI, pieces of information such as an IP address of the origin of an attack and a hash value indicating malware are mainly used. Such pieces of information are referred to as a block list, for example. In other words, the government and corporations use such a block list as, for example, an access control list (ACL) of a firewall, that is, a list of IP addresses to be repelled.

However, the block list may have a considerable volume. Thus, if all of the pieces of address information included in the block list are continuously managed as targets of access control, for example, performance of a firewall may deteriorate.

In particular, having the IP address of the origin of an attack recognized is fatal to cyberattackers, and thus the IP address of the origin of an attack tends to be rarely continuously used. Thus, it is highly likely that the IP address of the origin of an attack is deleted immediately after the attack. In other words, it is highly likely that the cyberattacker carries out a new attack using another IP address. It is hence highly likely that the generated block list immediately becomes obsolete.

In view of this, the present example embodiments have an example object to appropriately manage address information that may be a target of access control. More specifically, the present example embodiments have an example object to appropriately determine whether or not it is effective for management of address information that may be a target of access control.

### (2) Technical Features

In the example embodiments of the present invention, address information as a management target for access control via a communication network is obtained, and an effective management period of the management target for the access control is set for the address information, based on information related to the address information.

With this configuration, for example, the address information that may be a target of the access control can be appropriately managed. Note that the technical features described above are a specific example of the example embodiments of the present invention, and as a matter of course, the example embodiments of the present invention are not limited to the technical features described above.

### 2. First Example Embodiment

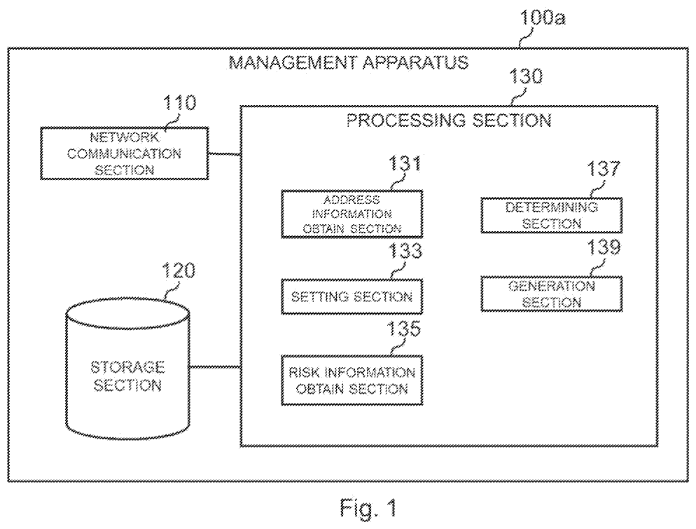

Next, with reference to FIG. 1 to FIG. 13, a first example embodiment will be described.

### 2.1. Configuration of Management Apparatus 100a

With reference to FIG. 1, an example of a configuration of a management apparatus 100a according to the first example embodiment will be described. FIG. 1 is a block diagram illustrating an example of a schematic configuration of the management apparatus 100a according to the first example embodiment. With reference to FIG. 1, the management apparatus 100a includes a network communication section 110, a storage section 120, and a processing section 130.

### (1) Network Communication Section 110

The network communication section 110 receives a signal from a network and transmits a signal to the network.

### (2) Storage Section 120

The storage section 120 temporarily or permanently stores programs (instructions) and parameters for operations of the management apparatus 100a as well as various data. The programs include one or more instructions for the operations of the management apparatus 100a.

### (3) Processing Section 130

The processing section 130 provides various functions of the management apparatus 100a. The processing section 130 includes an address information obtain section 131, a setting section 133, a risk information obtain section 135, a determining section 137, and a generation section 139. Note that the processing section 130 may further include constituent elements other than these constituent elements. In other words, the processing section 130 may also perform operations other than the operations of these constituent elements. Specific operations of the address information obtain section 131, the setting section 133, the risk information obtain section 135, the determining section 137, and the generation section 139 will be described later in detail.

### (4) Implementation Example

The network communication section 110 may be implemented with a network adapter and/or a network interface card, and the like. The storage section 120 may be implemented with a memory (e.g., a nonvolatile memory and/or a volatile memory) and/or a hard disk, and the like. The processing section 130 may be implemented with one or more processors. The address information obtain section 131, the setting section 133, the risk information obtain section 135, the determining section 137, and the generation section 139 may be implemented with the same processor, or may be separately implemented with different processors. The memory (storage section 120) may be included in the one or more processors or may be provided outside the one or more processors.

The management apparatus 100a may include a memory that stores programs (instructions), and one or more processors that can execute the programs (instructions). The one or more processors may execute the programs to thereby perform the operations of the processing section 130 (operations of the address information obtain section 131, the setting section 133, the risk information obtain section 135, the determining section 137, and/or the generation section 139). The programs may be programs for causing the processor(s) to execute the operations of the processing section 130 (operations of the address information obtain section 131, the setting section 133, the risk information obtain section 135, the determining section 137, and/or the generation section 139).

### 2.2. Operation Example

Next, an operation example according to the first example embodiment will be described.

According to the first example embodiment, the management apparatus 100a (address information obtain section 131) obtains address information as a management target for access control via a communication network. The management apparatus 100a (setting section 133) sets, for the address information, an effective management period of the management target for the access control, based on information related to the address information.

According to the first example embodiment, by setting the effective management period of the management target for the access control for the address information, the address information that may be a target of the access control can be appropriately managed.

### (1) Address Information

Specifically, examples of the address information include pieces of information (an IP address, a domain name, and the like) included in threat information as described below. Specifically, the threat information is a list that suggests cyberattacks, and is a list of pieces of information related to attacks.

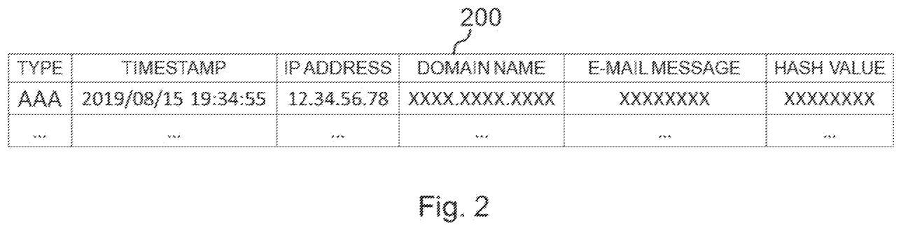

FIG. 2 is a diagram illustrating a specific example of threat information 200. As illustrated in FIG. 2, the threat information 200 is, for example, information related to a cyberattacks that the government and corporations have received. Specifically, threat information 200 is information in which a type of an observation point that observes access that may be a threat target, a timestamp related to time at which access is recognized as threatening access by the observation point, an IP address of the threatening access, a domain name of the threatening access, an e-mail message transmitted from the threatening access, malware transmitted from the threatening access, and the like are associated with each other. When the threat information 200 includes malware, a hash value of the malware is also included in the threat information 200.

The threat information 200 described above is, for example, collected by the address information obtain section 131. In other words, the address information obtain section 131 receives the threat information 200 through crawling for automated collection, or receives the threat information 200 from another system. For example, the address information obtain section 131 causes the storage section 120 to store the collected threat information 200.

### (2) Information Related to Address Information

The information related to the address information includes, for example, location information assigned to the address. Specifically, examples of the location information assigned to the address information include country information and area information specified based on the address information (for example, the IP address) and the like.

### Second Specific Example

The information related to the address information may include attack history information related to a cyberattack from a network node specified by the address information.

Specifically, the attack history information is history information acquired based on a plurality of pieces of threat information having different obtaining paths and obtaining timings as will be specifically described later. More specifically, the attack history information includes information related to the number of appearances (hereinafter also referred to as appearance frequency) of the address information appearing as the threat information in the plurality of pieces of threat information collected by a plurality of observation points on the communication network. For example, it can be determined that the address collected as the threat information by the plurality of observation points is highly likely to be the origin of the attack of the cyberattack. Each of the observation points is, for example, specified by the type included in the threat information 200 illustrated in FIG. 2.

Note that the attack history information may include information (attack frequency) related to the number of times of attacks of the cyberattacks in a predetermined period.

### (3) Effective Management Period

The effective management period includes a period from a time point when the address information becomes the management target to a time point when the address information is to be excluded from the management target. Such a period corresponds to, specifically, an effective management period for a hard timeout, in which validity forcibly expires at designated time.

The effective management period may include a period from a time point when last communication is performed from the network node specified by the address information to a time point when the address information is to be excluded from the management target. Such a period corresponds to, specifically, an effective management period for an idle timeout, in which validity is extended if there is an access that satisfies a predetermined condition from the network node before the designated time.

### (3-1) Setting Processing of Effective Management Period

### (3-1-1) First Specific Example: Setting Processing of Effective Management Period for Idle Timeout

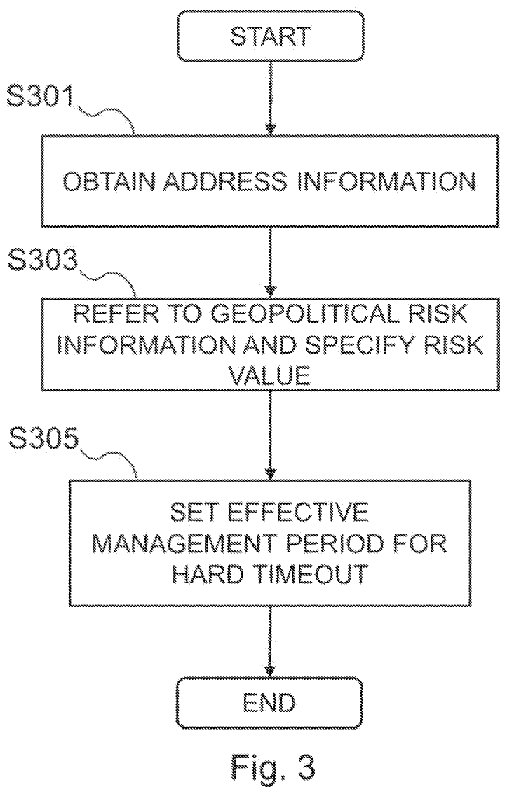

As the first specific example, setting processing of the effective management period for an idle timeout will be described. FIG. 3 is a flowchart illustrating a flow of an example of the setting processing of the effective management period for an idle timeout.

First, with reference to FIG. 3, the management apparatus 100a (setting section 133) accesses the storage section 120 and the like, and obtains the address information as a setting target (Step S301).

Next, the management apparatus 100a (setting section 133) refers to geopolitical risk information, and specifies a risk value associated with the location information (for example, the country information) assigned to the address information (Step S303). Here, the geopolitical risk information is, for example, information that is subjected to information update on a monthly or daily basis, and is information including a geopolitical risk value of each country. Such information is, for example, obtained by the risk information obtain section 135, and is stored in the storage section 120.

Next, the management apparatus 100a (setting section 133) sets the effective management period for a hard timeout, based on the risk value associated with the location information (Step S305). For example, the set effective management period for a hard timeout is stored in the storage section 120. With this, the processing illustrated in FIG. 3 is terminated.

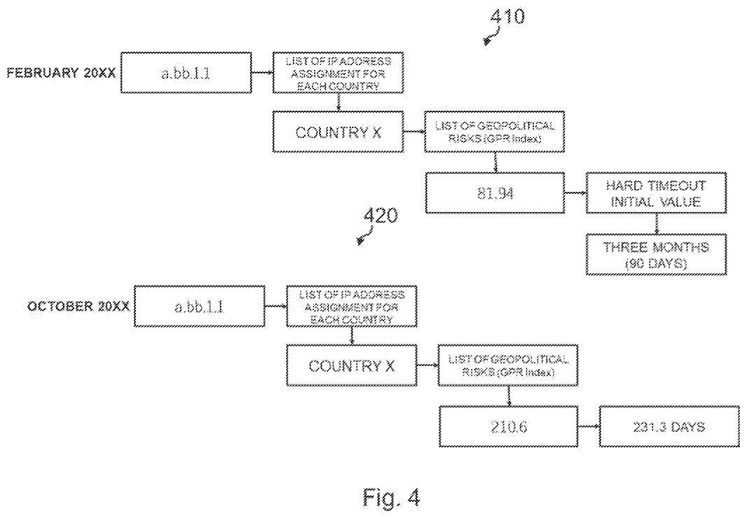

FIG. 4 is a diagram illustrating a specific example of change of the effective management period for a hard timeout according to change of the risk value. With reference to FIG. 4, for example, a case 410 is an example of the effective management period for a hard timeout that is calculated based on the risk value at the time point of February 20xx. In other words, in the case 410, the risk value of “country X” being a country assigned to the IP address is specified as “81.94” based on the geopolitical risk information, and “90 days” is set as the initial value of the effective management period for a hard timeout.

In contrast, a case 420 is an example of the effective management period for a hard timeout that is calculated based on the risk value at a time point (October 20xx) after the elapse of eight months since the case 410. In the case 420, in comparison to the case 410, the risk value of “country X” being a country assigned to the IP address is high, in other words, the risk value changes from “81.94” to “210.6”, and the effective management period for a hard timeout is thus set to “231.3 days”.

In the example illustrated in FIG. 4, as a specific example of the geopolitical risk information, for example, the geopolitical risk (GPR) index, which numerically indicates geopolitical risks, is used. Note that not only the GPR Index but also other evaluation indexes related to geopolitical risks may be used as the geopolitical risk information.

In this manner, according to the first specific example, the management apparatus 100a (setting section 133) can appropriately set the effective management period for a hard timeout by taking the geopolitical risk information into consideration.

### (3-1-2) Second Specific Example: Setting Processing of Effective Management Period for Idle Timeout

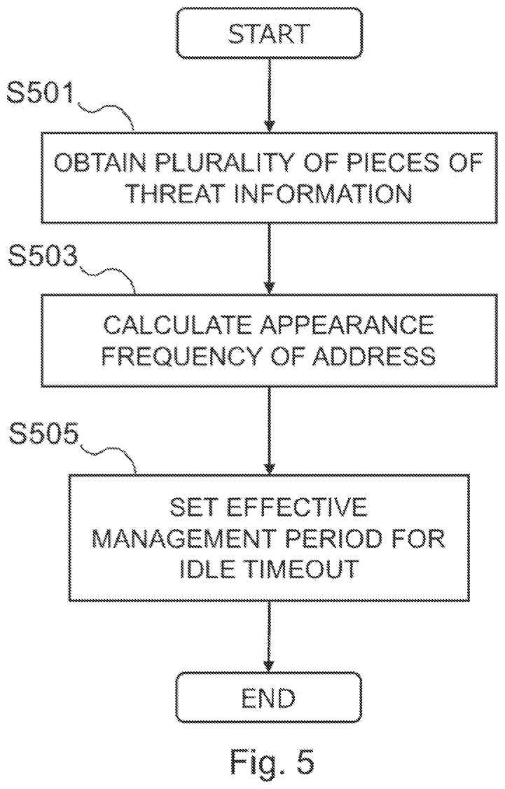

With reference to FIG. 5, a specific example of setting processing of the effective management period for an idle timeout will be described. FIG. 5 is a flowchart illustrating a flow of an example of the setting processing of the effective management period for an idle timeout.

With reference to FIG. 5, the management apparatus 100a (setting section 133) accesses the storage section 120 and the like, and obtains a plurality of pieces of threat information having collection times, collection paths, and the like different from each other (Step S501).

Next, the management apparatus 100a (setting section 133) calculates the appearance frequency of addresses (for example, IP addresses) included in the address information as a setting target of the effective management period, based on the plurality of pieces of threat information (Step S503).

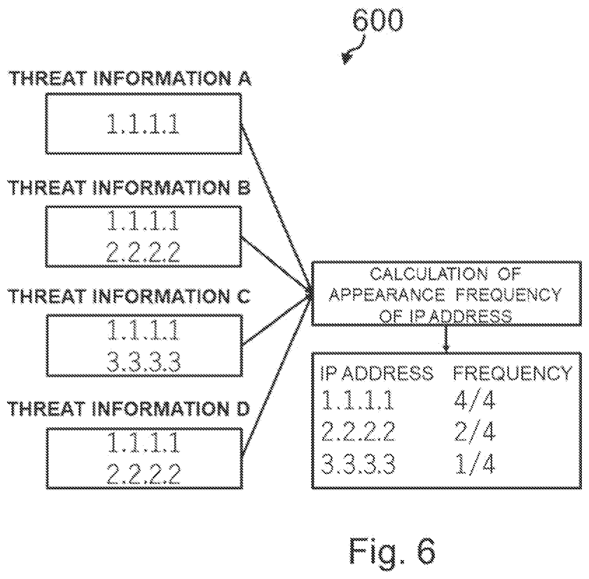

FIG. 6 is a diagram illustrating a calculation case 600 of the appearance frequency of addresses. In the calculation case 600, for example, the appearance frequency of an IP address is calculated based on four pieces of threat information A to D. For example, an IP address “1.1.1.1” is considered. The IP address “1.1.1.1” is included in each of the four pieces of threat information A to D, and the appearance frequency thereof is calculated as 4/4. An IP address “2.2.2.2” is considered. The IP address “2.2.2.2” is included in each of two pieces of threat information B and D, and the appearance frequency thereof is calculated as 2/4. When access from a certain address is collected as the threat information at many observation points, the appearance frequency of the address is high. Accordingly, it may be determined that an address having high appearance frequency is highly likely to be the origin of an attack of a cyberattack.

Next, the management apparatus 100a (setting section 133) sets the effective management period for an idle timeout, based on the calculated appearance frequency of the addresses (Step S505). For example, it is assumed that, as the appearance frequency is higher, the risk is higher, in other words, necessity as an access target is higher. Thus, as the appearance frequency of an address is higher, the management apparatus 100a (setting section 133) sets the effective management period for an idle timeout so that the period is longer. In a case of application to the calculation case 600 illustrated in FIG. 6, regarding the IP address “1.1.1.1” and the IP address “2.2.2.2”, the effective management period for an idle timeout is set to 14 days and 7 days, respectively.

For example, the set effective management periods for an idle timeout are stored in the storage section 120. With this, the processing illustrated in FIG. 5 is terminated.

### (3-1-3) Additional Notes

For example, in addition to the first and second specific examples described above, various modifications can be made. For example, the management apparatus 100a (setting section 133) may calculate the effective management period for a hard timeout based on the appearance frequency of addresses, or may calculate the effective management period for an idle timeout based on the geopolitical risk information.

### (3-2) Adjustment of Effective Management Periods

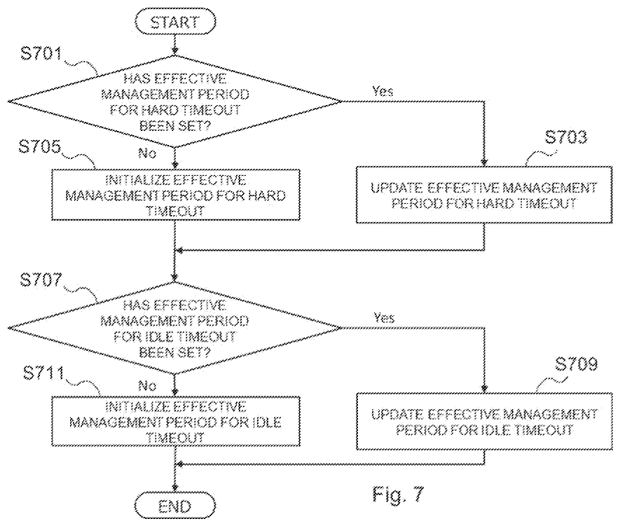

Next, with reference to FIG. 7, processing of adjusting the effective management periods will be described. FIG. 7 is a flowchart illustrating a flow of an example of processing of adjusting the effective management periods.

With reference to FIG. 7, the management apparatus 100a (setting section 133) accesses the storage section 120, and determines whether or not the effective management period for a hard timeout has been set regarding the address information as a setting target of the effective management period, for example (Step S701). Then, when the effective management period for a hard timeout has been set (S701: Yes), the management apparatus 100a (setting section 133) updates the effective management period for a hard timeout (Step S703), and proceeds to Step S707. In contrast, when the effective management period for a hard timeout has not been set (S701: No), the management apparatus 100a (setting section 133) initializes the effective management period for a hard timeout (Step S705), and proceeds to Step S707.

Next, the management apparatus 100a (setting section 133) accesses the storage section 120, and determines whether or not the effective management period for an idle timeout has been set regarding the address information as a setting target of the effective management period, for example (Step S707). Then, when the effective management period for an idle timeout has been set (S707: Yes), the management apparatus 100a (setting section 133) updates the effective management period for an idle timeout (Step S709), and terminates the processing illustrated in FIG. 7. In contrast, when the effective management period for an idle timeout has not been set (S707: No), the management apparatus 100a (setting section 133) initializes the effective management period for an idle timeout (Step S711), and terminates the processing illustrated in FIG. 7.

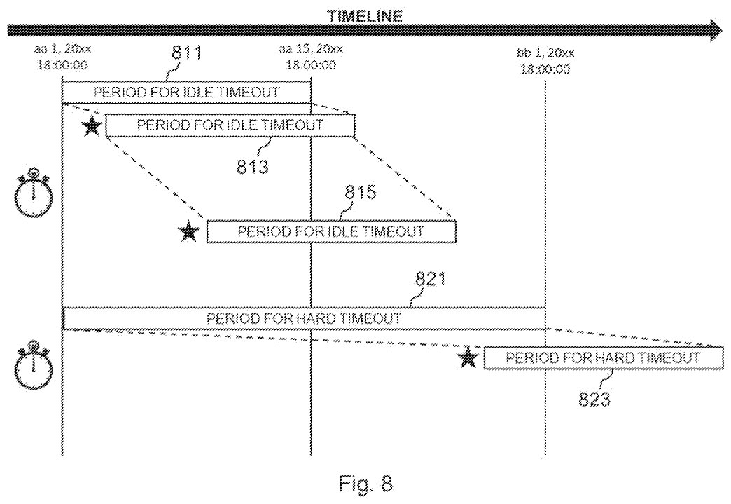

FIG. 8 is a diagram illustrating a specific example of processing of updating the effective management periods. With reference to FIG. 8, first, after a period 811 is initialized, the effective management period for an idle timeout is updated in order of periods 813 and 815 every time there is a request from the IP address of a setting target. Even after a period 821 is initialized, the effective management period for a hard timeout is updated in a period 823 at timing when new geopolitical risk information is obtained, for example, regardless of whether or not there is a request from the IP address of the setting target.

### (4) Setting of Effective Management Period based on Communication Check

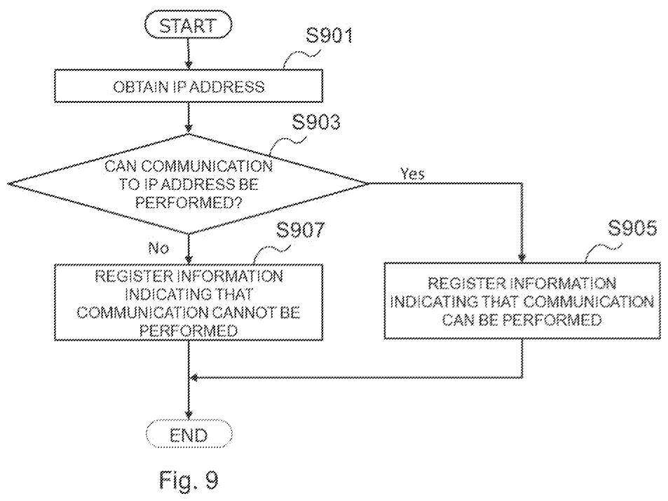

The management apparatus 100a (determining section 137) may determine whether or not communication can be performed with the network node specified by the address information. FIG. 9 is a flowchart illustrating a flow of an example of processing performed by the determining section 137.

With reference to FIG. 9, the management apparatus 100a (determining section 137) accesses the storage section 120, and obtains address information (IP address) of a setting target of the effective management period (Step S901).

Next, the management apparatus 100a (determining section 137) determines whether or not communication to the IP address can be performed (Step S903). Specifically, the management apparatus 100a (determining section 137) may determine whether or not communication to the IP address can be performed by using a typical communication check tool such as ping and Traceroute. Note that not only the above examples but also other communication check tools may be used.

When it is determined that communication can be performed (S903: Yes), the management apparatus 100a (determining section 137) registers information indicating that communication can be performed (Step S905). In other words, information indicating that communication can be performed is stored in the storage section 120. With this, the processing illustrated in FIG. 9 is terminated.

In contrast, when it is determined that communication cannot be performed (S903: No), the management apparatus 100a (determining section 137) registers information indicating that communication cannot be performed (Step S907). In other words, information indicating that communication cannot be performed is stored in the storage section 120. With this, the processing illustrated in FIG. 9 is terminated.

As illustrated in FIG. 9 described above, when the determining section 137 determines whether or not communication to the IP address can be performed, the management apparatus 100a (setting section 133) may set the effective management period, based on results of the determination related to whether or not communication can be performed. For example, when the management apparatus 100a (setting section 133) cannot perform communication with the network node specified by the address information, the management apparatus 100a (setting section 133) may set the effective management period to 0, and may set the effective management period so that the period is shorter than that when the management apparatus 100a (setting section 133) can perform communication.

### (5) Generation of Information Related to Effective Management Period

The management apparatus 100a (generation section 139) generates information indicating correspondence between the address information and the effective management period set for the address. The information generated as described above is stored in the storage section 120, and thereby the information is managed.

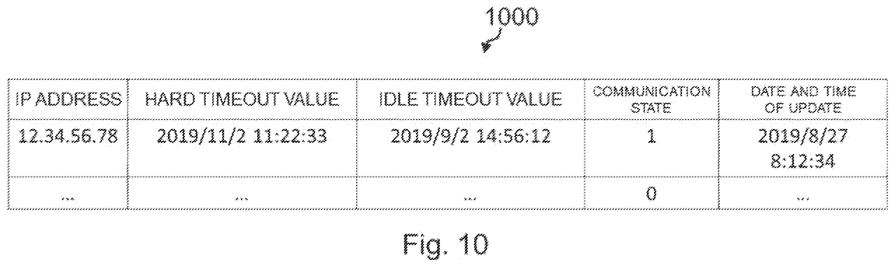

FIG. 10 is a diagram illustrating an example of information indicating the correspondence. With reference to FIG. 10, information 1000 indicating correspondence includes an IP address, a hard timeout value (end time of the effective management period for a hard timeout), an idle timeout value (end time of the effective management period for an idle timeout), a communication state, and date and time of last update. In the information 1000 illustrated in FIG. 10, for example, when the communication state is “1”, it indicates that communication can be performed, whereas when the communication state is “0”, it indicates that communicate cannot be performed.

### (6) Flow of Entire Processing of Management Apparatus 100a

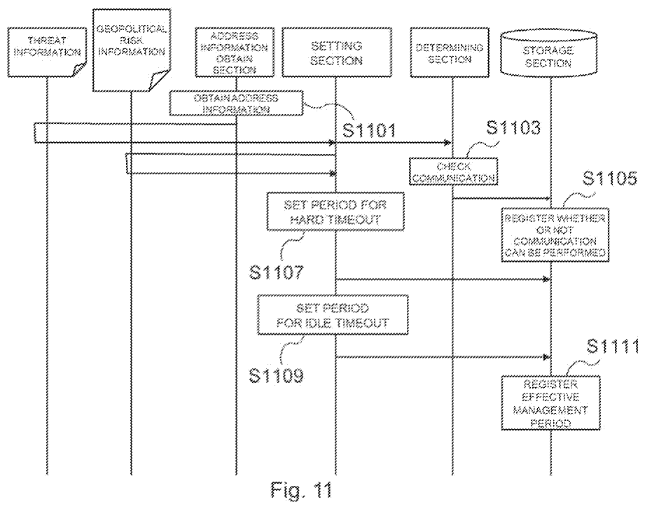

FIG. 11 is a time chart illustrating a flow of entire processing of the management apparatus 100a. With reference to FIG. 11, first, the address information included in the threat information is obtained by the address information obtain section (S1101). Next, communication check (determination whether or not communication can be performed) regarding the address information is performed by the management apparatus 100a (determining section 137) (S1103). Next, information related to the determination results (whether or not communication can be performed) is stored (registered) in the storage section 120 (S1105).

Next, the management apparatus 100a (setting section 133) sets the effective management period for a hard timeout related to the address information, based on the geopolitical risk information and the like (S1107). The set effective management period is stored (registered) in the storage section 120. Next, the management apparatus 100a (setting section 133) sets the effective management period for an idle timeout related to the address information, based on the threat information and the like (S1109). The set effective management period is stored (registered) in the storage section 120.

Next, the information indicating the correspondence between the address information and the effective management period, which is the information generated by the management apparatus 100a (generation section 139), is stored (registered) in the storage section 120 as information related to the effective management period (S1111). Subsequently, the processing illustrated in FIG. 11 is terminated.

According to the processing illustrated in FIG. 11 described above, regarding the threat information such as an IP address, the effective management period for a hard timeout utilizing the geopolitical risk information can be set, and the effective management period for an idle timeout can be set by utilizing occurrence frequency of the threat information.

In addition, by utilizing the latest threat information, the management apparatus 100a can manage the effective management period by taking update of each of the effective management periods described above and information indicating whether or not communication to the IP address can be performed into consideration. In this manner, the management apparatus 100a can appropriately manage validity of the block list, for example.

### 2.3. Example Alteration

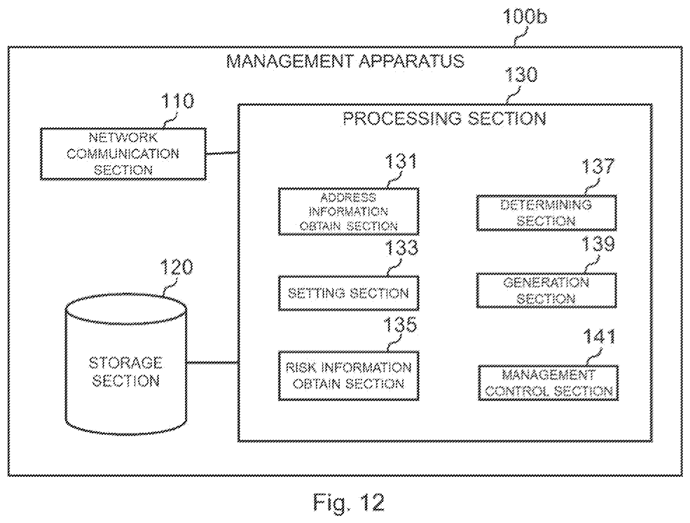

Next, with reference to FIG. 12, a management apparatus 100b according to an example alteration will be described. FIG. 12 is a block diagram illustrating an example of a schematic configuration of a management apparatus 100b according to the example alteration. With reference to FIG. 12, the management apparatus 100b is different from the management apparatus 100a described above in that the processing section 130 further includes a management control section 141 that manages the address information as a management target based on the effective management period set by the setting section 133. Processing related to the management control section 141 will be described below.

Specifically, the management apparatus 100b (management control section 141) performs processing of excluding the address information from the management target in a case that the effective management period set for the address information elapses.

As an example, the management apparatus 100b (management control section 141) activates a timer function for the hard timeout and the idle timeout set for the IP address, and at the moment that respective effective management periods have elapsed, the management apparatus 100b (management control section 141) instructs a security device (for example, a device configuring a firewall) capable of communicating with the management apparatus 100b to delete the IP address from the block list.

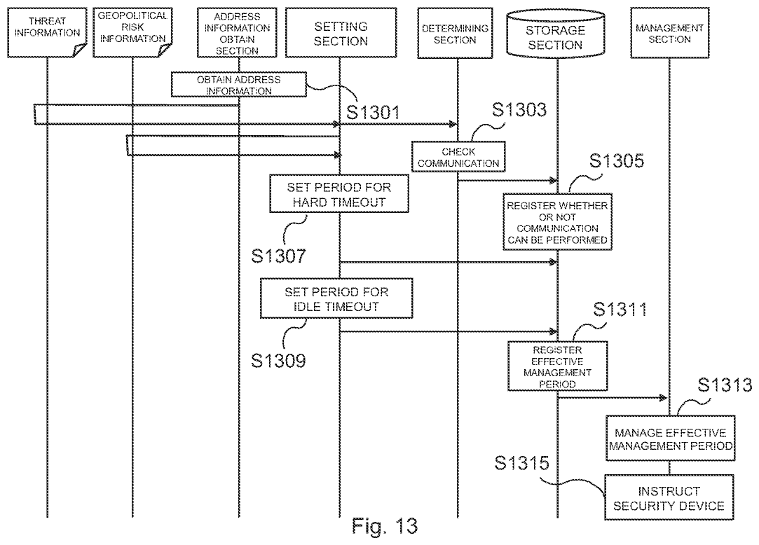

FIG. 13 is a time chart illustrating a flow of entire processing of the management apparatus 100b. With reference to FIG. 13, the processing illustrated in S1301 to S1311 is similar to the processing illustrated in S1101 to 1111 illustrated in FIG. 11 described above, and thus description thereof will be omitted.

When information related to the effective management period is registered (S1311), for example, the management apparatus 100b (management control section 141) manages the effective management periods such as by activating a timer function for the hard timeout and the idle timeout (S1313). Then, the management apparatus 100b (management control section 141) performs access control, such as instructing a security device to delete the IP address, based on the timer function (S1315).

According to the processing illustrated in FIG. 13, by managing validity of the IP address using a timer function, update or deletion of an address list (block list) as a target of access control for a security device can be controlled.

### 3. Second Example Embodiment

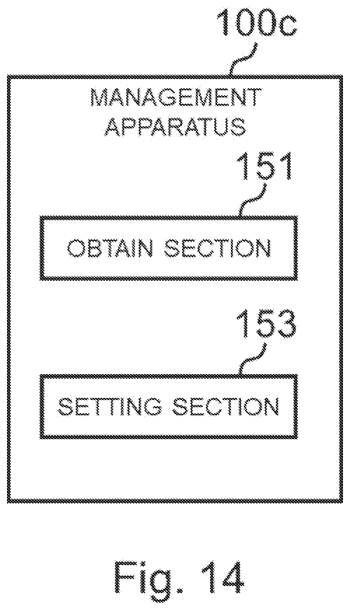

Next, with reference to FIG. 14, a second example embodiment of the present invention will be described. While the first example embodiment described above is a specific example embodiment, the second example embodiment is a more generalized example embodiment.

### 3.1. Configuration of Management Apparatus 100c

FIG. 14 is a block diagram illustrating an example of a schematic configuration of a management apparatus 100c according to the second example embodiment. With reference to FIG. 14, the management apparatus 100c includes an obtain section 151 and a setting section 153.

The obtain section 151 and the setting section 153 may be implemented with one or more processors, a memory (e.g., a nonvolatile memory and/or a volatile memory), and/or a hard disk. The obtain section 151 and the setting section 153 may be implemented with the same processor, or may be separately implemented with different processors. The memory may be included in the one or more processors or may be provided outside the one or more processors.

### 3.2. Operation Example

An operation example according to the second example embodiment will be described.

According to the second example embodiment, the management apparatus 100c (obtain section 151) obtains address information as a management target for access control via a communication network. The management apparatus 100c (setting section 153) sets, for the address information, an effective management period as the management target for the access control, based on information related to the address information.

### Relationship with First Example Embodiment

As an example, the obtain section 151 and the setting section 153 included in the management apparatus 100c according to the second example embodiment may perform the operations of the address information obtain section 131 and the setting section 133 included in the management apparatuses 100a and 100b according to the first example embodiment, respectively. In this case, description regarding the first example embodiment may also be applied to the second example embodiment. Note that the second example embodiment is not limited to this example.

The second example embodiment has been described above. According to the second example embodiment, the address information that may be a target of access control can be appropriately managed.

### 4. Other Example Embodiments

Descriptions have been given above of the example embodiments of the present invention. However, the present invention is not limited to these example embodiments. It should be understood by those of ordinary skill in the art that these example embodiments are merely examples and that various alterations are possible without departing from the scope and the spirit of the present invention.

For example, the steps in the processing described in the Specification may not necessarily be executed in time series in the order described in the corresponding sequence diagram. For example, the steps in the processing may be executed in an order different from that described in the corresponding sequence diagram or may be executed in parallel. Some of the steps in the processing may be deleted, or more steps may be added to the processing.

An apparatus including constituent elements (e.g., the obtain section and/or the setting section) of the management apparatus described in the Specification (e.g., one or more apparatuses (or units) among a plurality of apparatuses (or units) constituting the management apparatus or a module for one of the plurality of apparatuses (or units)) may be provided. Moreover, methods including processing of the constituent elements may be provided, and programs for causing a processor to execute processing of the constituent elements may be provided. Moreover, non-transitory computer readable recording media (non-transitory computer readable media) having recorded thereon the programs may be provided. It is apparent that such apparatuses, modules, methods, programs, and non-transitory computer readable recording media are also included in the present invention.

Some of or all the above-described example embodiments can be described as in the following Supplementary Notes, but are not limited to the following.

### Supplementary Note 1

A management apparatus including:

an obtain section configured to obtain address information as a management target for access control via a communication network; and

a setting section configured to set, for the address information, an effective management period of the management target for the access control, based on information related to the address information.

### Supplementary Note 2

The management apparatus according to supplementary note 1, wherein

the information related to the address information includes location information assigned to the address information.

### Supplementary Note 3

The management apparatus according to supplementary note 1, wherein

the information related to the address information includes attack history information related to a cyberattack from a network node specified by the address information.

### Supplementary Note 4

The management apparatus according to supplementary note 3, wherein

the attack history information includes information related to the number of appearances of the address information appearing as threat information in a plurality of pieces of threat information collected by a plurality of observation points on the communication network.

### Supplementary Note 5

The management apparatus according to any one of supplementary notes 1 to 4, further including

a determining section configured to determine whether or not communication can be performed with a network node specified by the address information, wherein

the setting section is configured to set the effective management period, based on the information related to the address information and the result of the determination.

### Supplementary Note 6

The management apparatus according to any one of supplementary notes 1 to 5, wherein

the effective management period includes a period from a time point when the address information becomes the management target to a time point when the address information is to be excluded from the management target.

### Supplementary Note 7

The management apparatus according to any one of supplementary notes 1 to 5, wherein

the effective management period includes a period from a time point when last communication is performed from the network node specified by the address information to a time point when the address information is to be excluded from the management target.

### Supplementary Note 8

The management apparatus according to any one of supplementary notes 1 to 7, further including

a management control section configured to manage the address information as the management target, based on the effective management period.

### Supplementary Note 9

The management apparatus according to supplementary note 8, wherein

the management control section is configured to perform processing of excluding the address information from the management target after the effective management period set for the address information elapses.

### Supplementary Note 10

The management apparatus according to any one of supplementary notes 1 to 9, further including

a generation section configured to generate information indicating correspondence relation between the address information and the effective management period.

### Supplementary Note 11

A management method including:

obtaining address information as a management target for access control via a communication network; and

setting, for the address information, an effective management period of the management target for the access control, based on information related to the address information.

### Supplementary Note 12

A program for causing a computer to execute:

obtaining address information as a management target for access control via a communication network; and

setting, for the address information, an effective management period of the management target for the access control, based on information related to the address information.

### INDUSTRIAL APPLICABILITY

In access management via a communication network, address information that may be a target of access control can be appropriately managed.

### REFERENCE SIGNS LIST

### 100a, 100b, 100c Management Apparatus

### 131 Address Information Obtain Section

### 133, 153 Setting Section

### 135 Risk Information Obtain Section

### 137 Determining Section

### 139 Generation Section

### 141 Management Control Section

### 151 Obtain Section

What is claimed is:

1. A management apparatus comprising:
a memory storing instructions; and
one or more processors configured to execute the instructions to:
obtain address information as a management target for access control via a communication network; and
for the address information, an effective management period of the management target for the access control, based on information related to the address information.

2. The management apparatus according to claim 1, wherein
the information related to the address information includes location information assigned to the address information.

3. The management apparatus according to claim 1, wherein
the information related to the address information includes attack history information related to a cyberattack from a network node specified by the address information.

4. The management apparatus according to claim 3, wherein
the attack history information includes information related to the number of appearances of the address information appearing as threat information in a plurality of pieces of threat information collected by a plurality of observation points on the communication network.

5. The management apparatus according to claim 1, wherein
the one or more processors are configured to execute the instructions to:
determine whether or not communication can be performed with a network node specified by the address information, and
the setting includes set the effective management period, based on the information related to the address information and the result of the determination.

6. The management apparatus according to claim 1, wherein
the effective management period includes a period from a time point when the address information becomes the management target to a time point when the address information is to be excluded from the management target.

7. The management apparatus according to claim 1, wherein
the effective management period includes a period from a time point when last communication is performed from the network node specified by the address information to a time point when the address information is to be excluded from the management target.

8. The management apparatus according to claim 1, wherein
the one or more processors are configured to execute the instructions to:
manage the address information as the management target, based on the effective management period.

9. The management apparatus according to claim 8, wherein
the one or more processors are configured to execute the instructions to perform processing of excluding the address information from the management target after the effective management period set for the address information elapses.

10. The management apparatus according to claim 1, wherein
the one or more processors are configured to execute the instructions to generate information indicating correspondence relation between the address information and the effective management period.

11. A management method comprising:
obtaining address information as a management target for access control via a communication network; and
setting, for the address information, an effective management period of the management target for the access control, based on information related to the address information.

12. A non-transitory computer readable recording medium storing a program for causing a computer to execute:
obtaining address information as a management target for access control via a communication network; and
setting, for the address information, an effective management period of the management target for the access control, based on information related to the address information.
